(19) United States
(12) Patent Application Publication
(10) Pub. No.: US 2025/0319717 A1
(43) Pub. Date: Oct. 16, 2025

(54) Decision Making Apparatus and Method to Randomize and Select Different Combinations of Ideas

(71) Applicants: Tricia Ann Spencer, Parker, CO (US); Andrew Joseph Spencer, Parker, CO (US)

(72) Inventors: Tricia Ann Spencer, Parker, CO (US); Andrew Joseph Spencer, Parker, CO (US)

(21) Appl. No.: 18/600,691

(22) Filed: Apr. 12, 2024

(51) Int. Cl. B42D 15/00

(52) U.S. Cl. CPC B42D 15/0086

(57) ABSTRACT

A decision making apparatus is provided and comprises a main backing, a first disk, a second disk, and a snap fit spinner arrow assembly. The apparatus randomizes and points to different combinations of ideas. The first disk and second disk are concentrically aligned with a circle printed on the main backing, wherein the circle, first disk, and second disk have different ideas written around their circumferential paths. The main backing, first disk, and second disk are contained vertically, horizontally, and concentrically by said snap fit spinner arrow assembly. The circle, first disk, and second disk are all subsequently smaller diameters in order for the ideas written on each disk and circle to be seen all at once. The first disk and second disk can be individually rotated, and the snap fit spinner arrow is rotated in order to simultaneously point to one idea on each disk and circle.

### BACKGROUND

The present invention relates to the field of decision making and can be applied to any combination of ideas that require the user to make a decision upon. As is well known, the ability to make a decision can be difficult for any individual. Being able to identify and quickly choose a combination of ideas, for example: what foods to cook and how, what workout routine to perform and when, what activity to do on what day, or what ideas, shapes, colors, and textures to include in your art can prove to be difficult and time consuming while complicating decision making efficiencies and capabilities.

### SUMMARY OF THE INVENTION

The following is intended to be a brief summary of the invention and is not intended to limit the scope of the invention.

In view of the background section above, an objective of the present invention is to provide an apparatus and method to randomize and select different combinations of ideas to support making decisions quickly and easily. The invention works by aligning and concentrically securing together at least one differently sized disk on top of a circle that is printed on a main backing. For example, aligning and securing one, two, or three disks on top of a larger printed circle concentrically. Each disk is sized differently and subsequently smaller in diameter so as you stack the disks, a portion of each disk can be viewed all at once. Each disk and printed circle is divided into a number of sections with ideas written within those subdivided sections around their circumferential paths. The disk(s) and printed circle are combined, contained, and concentrically aligned utilizing a snap fit spinner arrow assembly. The disk(s) and main backing can be freely and individually rotated while remaining aligned. The snap fit spinner arrow assembly includes a snap fit spinner arrow that can then be spun in order to simultaneously point to one idea on each disk and circle.

### DESCRIPTION OF THE DRAWINGS

FIG. 1 is the front view of the apparatus.

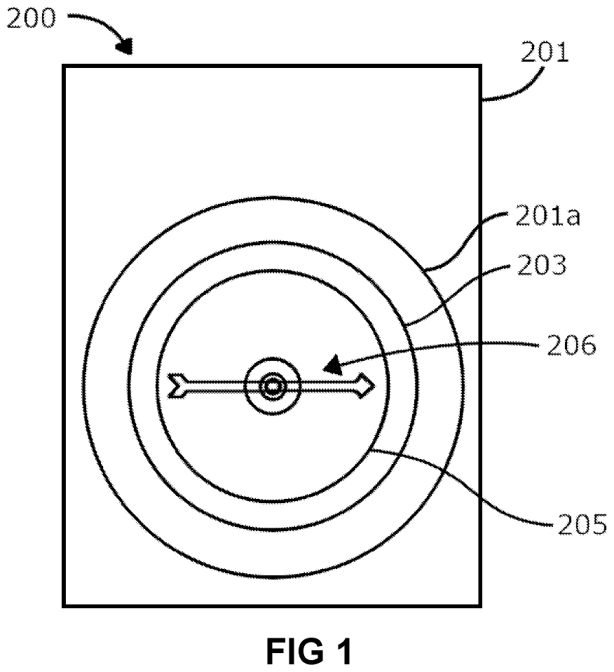

FIG. 2 is the bottom view of the apparatus.

FIG. 3 is the exploded bottom view of the apparatus.

FIG. 4 is the isometric view of the apparatus.

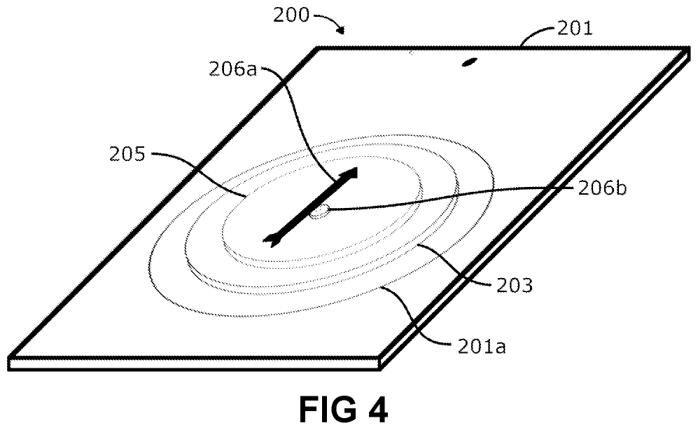

FIG. 5 is the exploded isometric view of the apparatus.

FIG. 6 is the front view of the snap fit arrow assembly.

FIG. 7 is the exploded front view of the snap fit arrow assembly.

FIG. 8 displays an example of how ideas are written along the circumferential path of a circle.

### DETAILED DESCRIPTION

The specific implementation manners of the present invention are further described in detail in this section with reference to the accompanying drawings to make the invention more clear and easier to understand.

The decision making apparatus 200 comprises a rectangular shaped paper board main backing 201 (which comprises a printed circle 201a), a circular shaped paper board spacer 202, a circular shaped paper board disk 203, a circular shaped paper board spacer 204, a circular shaped paper board disk 205, and a snap fit arrow assembly 206 which comprises a snap fit spinner arrow 206a, a snap fit top 206b, and a snap fit bottom 206c.

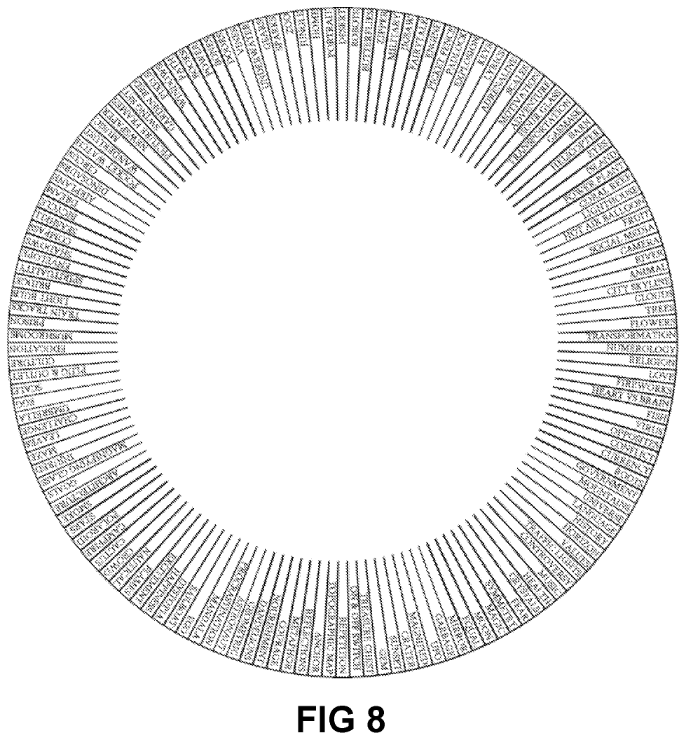

The main backing 201 is provided with circle 201a printed on it, listing ideas around said circle 201a's circumferential path as shown in FIG. 8, and includes a hole cut at the center of the printed circle 201a. The main backing 201 has a hole cut at its top to support hanging the apparatus.

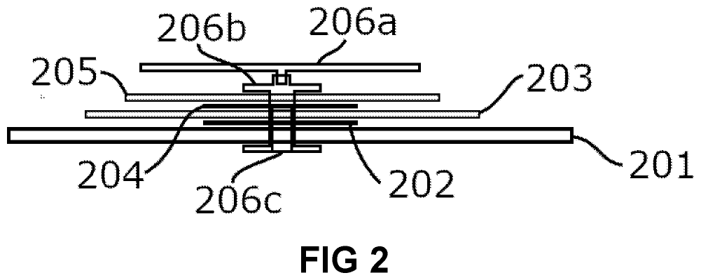

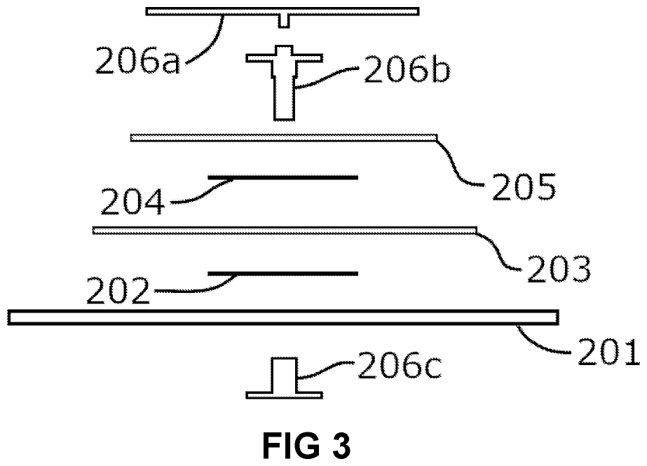

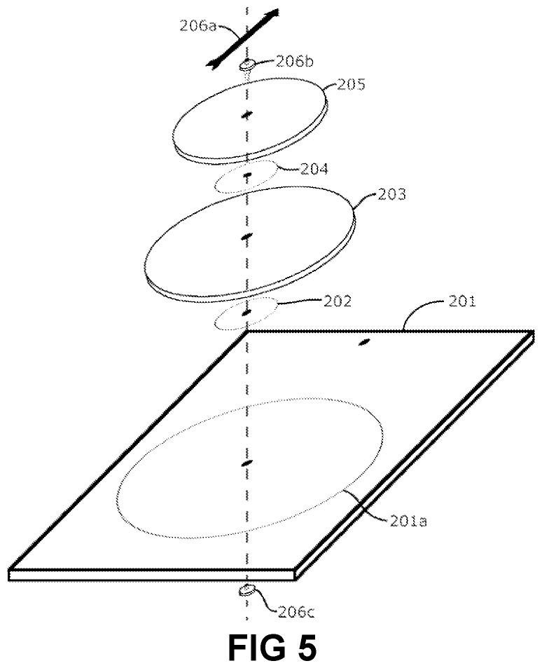

Spacer 202 is made from a paper board material or similar and is sized to be smaller than disk 203 and act as a separating component between disk 203 and main backing 201. Spacer 202 is not to be seen when layered and stacked between main backing 201 and disk 203 (refer to FIG. 2, FIG. 3, and FIG. 5). Spacer 202 includes a hole cut at its center with the same diameter as the hole cut in the center of the printed circle 201a.

Disk 203 is made from a paper board material or similar and the diameter is sized so that it does not cover the ideas written on the printed circle 201a when layered and stacked on top of spacer 202 and main backing 201's printed circle 201a. As shown in FIG. 8, disk 203 has ideas printed around its circumferential path that differ but are related to the ideas written on the printed main circle 201a. Disk 203 includes a hole cut at its center with the same diameter as the hole cut in the center of the printed circle 201a and spacer 202.

Spacer 204 is made from a paper board material or similar and is sized to be smaller than disk 205 and act as a separating component between disk 205 and disk 203. Spacer 204 is not to be seen when layered and stacked between disk 203 and disk 205 (refer to FIG. 2, FIG. 3, and FIG. 5). Spacer 204 includes a hole cut at its center with the same diameter as the hole cut in the center of the printed circle 201a, spacer 202, and disk 203.

Disk 205 is made from a paper board material or similar and the diameter is sized so that it does not cover the ideas written on disk 203 or printed circle 201a when layered and stacked on top of main backing 201's printed circle 201a, spacer 202, Disk 203, and spacer 204. As shown in FIG. 8, the disk 205 has ideas printed around its circumferential path that differ but are related to the ideas written on printed circle 201a and disk 203. Disk 205 includes a hole cut at its center with the same diameter as the hole cut in the center of the printed circle 201a, spacer 202, disk 203, and spacer 204.

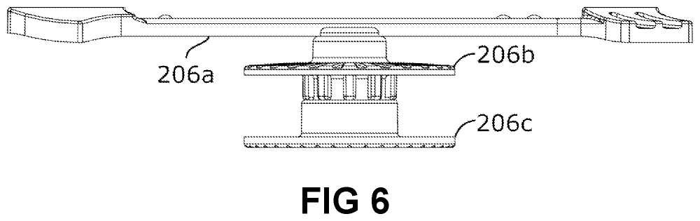

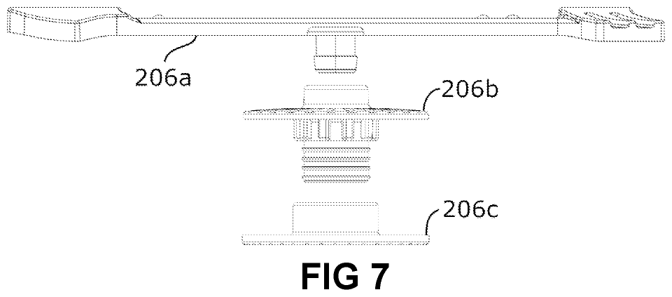

Once the disks and spacers are layered, stacked, and their center holes are aligned in the following order: main backing 201, spacer 202, disk 203, spacer 204, and disk 205, the snap fit arrow assembly 206 is installed. Referring to FIG. 5, the snap fit bottom 206c is brought up through the bottom of the hole cut in the center of printed circle 201a and feeds through all of the holes in the spacers and disks, while snap fit top 206b is brought down through the top and feeds down through all of the holes in the spacers and disks until snap fit top 206b and snap fit bottom 206c snap together. Referring to FIG. 6 and FIG. 7, the snap fit top 206b has a “male” portion which includes “ribs” that snap down into the “female” portion of the snap fit bottom 206c. The “female” portion of snap fit bottom 206c has an inner diameter and “lip” that is smaller than the outer diameter of the “ribs” on the “male” portion of the snap fit top 206b. This allows the “ribs” of the snap fit top 206b to snap down past the “lip” of the snap fit bottom 206c, holding the two parts in place while containing main backing 201, spacer 202, disk 203, spacer 204, and disk 205 concentrically, vertically, and horizontally. It should be noted that snap fit top 206b has four different “ribs” along its lower “male” portion, allowing snap fit top 206b to snap down to four different depths within snap fit bottom 206c. This is intended to allow for more space between the snap fit top 206b and snap fit bottom 206c, which increases the number of disks you can stack on top of one another.

Once the main backing 201, spacer 202, disk 203, spacer 204, and disk 205 are all contained by snap fit top 206b being installed into snap fit bottom 206c, snap fit spinner arrow 206a is snapped down into snap fit top 206b. Similarly to how snap fit top 206b and snap fit bottom 206c snap together, and referring to FIG. 6 and FIG. 7, snap fit spinner arrow 206a has a tapered “male” lower portion with a “lip” edge that snap fits down into the top “female” portion of snap fit top 206b. Snap fit top 206b has a “female” portion that has an inner diameter and “lip” that is smaller than the outer diameter of the snap fit spinner arrow 206a “lip” edge and when snapped together it allows for snap fit spinner arrow 206a to sit loosely within snap fit top 206b, but the “lips” do not allow them to come apart. The loose fitting allows for snap fit spinner arrow 206a to spin independently of snap fit top 206b, while remaining connected.

When all of the components are installed, the user rotates each independent disk. This method randomizes the combination of the ideas written down on circle 201a, disk 203, and disk 205. The snap fit spinner arrow 206a is then spun. Once snap fit spinner arrow 206a is done spinning, it points simultaneously to one idea written on circle 201a, one idea written on disk 203, and one idea written on disk 205. The ability to rotate the disks independently produces a very large and random number of different combinations of ideas from each disk and circle.

Although the teaching of the present application has been described in detail for the purpose of illustration, it is understood that such detail is solely for that purpose, and variations can be made therein by those skilled in the art without departing from the scope of the teaching of this application. For example, the apparatus has been described with a main backing that is rectangular in shape, but is understood that the main backing does not need to be rectangular, and it could have any other suitable shape. Further, the apparatus has been described with disks and spacers that are circular in shape, but it is understood that the disk and spacers do not need to be circular in shape, and they could be any other suitable shape. Additionally, the apparatus has been described with two total disks and two total spacers, but it is understood that the number of disks and spacers could be increased with additional layers of disks and spacers. Finally, the apparatus has been described with a three piece snap fit spinner arrow assembly, but it is understood that the components could be contained utilizing a wide variety of different styles of couplings or connections.

The invention claimed is:

1. A decision making apparatus for facilitating and recommending random combinations of ideas, said decision making apparatus comprising:
A main backing, wherein a circle is printed onto with ideas written around said circle's circumferential path;
A first disk that is sized to not fully cover said circle, wherein ideas are written around said first disks circumferential path, and said first disk is stacked on top of said main backing and concentrically aligned with said circle, and rotatably coupled with said main backing;
A second disk that is sized to not fully cover said circle or said first disk, wherein ideas are written around said second disks circumferential path, and said second disk is stacked on top of said first disk, concentrically aligned with said circle and said first disk, and rotatably coupled with said main backing and said first disk;
A snap fit spinner arrow assembly, comprising a snap fit spinner arrow, a snap fit top, and a snap fit bottom, wherein the said snap fit spinner arrow is rotatably coupled to said snap fit top, and said snap fit top is coupled with said snap fit bottom in order to vertically, horizontally, and concentrically contain said main backing, said first disk, and said second disk.

2. A decision making apparatus for facilitating and recommending random combinations of ideas according to claim 1, further comprising:
A third disk that is sized to not fully cover said circle, said first disk, or said second disk, wherein ideas are written around said third disks circumferential path, and said third disk is stacked on top of said second disk and concentrically aligned with said circle, said first disk, and said second disk, and rotatably coupled with said main backing, said first disk, and said second disk.

3. A decision making method for facilitating and recommending random combinations of ideas, said decision making method comprising:
A rotation of a first disk;
A rotation of a second disk;
A rotation of a snap fit spinner arrow in order for said snap fit spinner arrow to simultaneously point at said first disk and said second disk.

4. A decision making method for facilitating and recommending random combinations of ideas according to claim 3, further comprising:
A rotation of a third disk.
